(19) United States
(12) Patent Application Publication
(10) Pub. No.: US 2017/0174870 A1
(43) Pub. Date: Jun. 22, 2017

(54) RESIN COMPOSITION AND RESIN MOLDED ARTICLE

(71) Applicant: FUJI XEROX CO., LTD., Tokyo (JP)

(72) Inventor: Kenji YAO, Kanagawa (JP)

(73) Assignee: FUJI XEROX CO., LTD., Tokyo (JP)

(21) Appl. No.: 15/090,974

(22) Filed: Apr. 5, 2016

(30) Foreign Application Priority Data
Dec. 21, 2015 (JP) 2015-248602

(51) Int. Cl. C08L 1/10

(52) U.S. Cl. CPC C08L 1/10

(57) ABSTRACT

A resin composition includes 100 parts by weight of a cellulose derivative in which at least one hydroxyl group of cellulose is substituted with an acetyl group and from 5 parts by weight to 20 parts by weight of a non-reactive plasticizer that does not have a functional group capable of reacting with the cellulose derivative, and the resin composition exhibits a spiral flow length of 100 mm or more and less than 130 mm as a length of a spiral flow having a thickness of 2 mm under conditions of a temperature of 240° C. and an injection pressure of 90 MPa.

### CROSS-REFERENCE TO RELATED APPLICATIONS

This application is based on and claims priority under 35 USC 119 from Japanese Patent Application No. 2015-248602 filed Dec. 21, 2015.

### BACKGROUND

1. Technical Field

The invention relates to a resin composition and a resin molded article.

2. Related Art

In the related art, various resin compositions are used in various applications. In particular, resin compositions are used for household appliances, various parts of automobiles, housings, and the like. Meanwhile, thermoplastic resins are used even in parts such as housings of office equipment and electronic and electric equipment.

In recent years, plant-derived resins have been used, and there is a cellulose derivative as one of the plant-derived resins which have been well known in the art.

### SUMMARY

According to an aspect of the invention, there is provided a resin composition, including:

100 parts by weight of a cellulose derivative in which at least one hydroxyl group of cellulose is substituted with an acetyl group; and

from 5 parts by weight to 20 parts by weight of a non-reactive plasticizer that does not have a functional group capable of reacting with the cellulose derivative,

wherein the resin composition exhibits a spiral flow length of 100 mm or more and less than 130 mm as a length of a spiral flow having a thickness of 2 mm under conditions of a temperature of 240° C. and an injection pressure of 90 MPa.

### DETAILED DESCRIPTION

Hereinafter, exemplary embodiments which are an example of a resin composition and a resin molded article of the invention will be described.

Resin Composition

The resin composition according to the exemplary embodiment includes: 100 parts by weight of a cellulose derivative (hereinafter, referred to as “acetyl cellulose derivative”) in which at least one hydroxyl group of cellulose is substituted with an acetyl group; and 5 parts by weight to 20 parts by weight of a non-reactive plasticizer (hereinafter, simply referred to as “plasticizer”) which does not have a functional group capable of reacting with the cellulose derivative.

The length of a spiral flow (hereinafter referred to as “spiral flow length”) of the resin composition having a thickness of 2 mm under conditions of a temperature of 240° C. and an injection pressure of 90 MPa is 100 mm or more and less than 130 mm (preferably 101 mm or more and 128 mm or less).

Here, the spiral flow length refers to an index for evaluating the fluidity of the resin composition using a mold having a groove of a spiral shape. As the numerical value of the spiral flow length increases, the fluidity of the resin composition becomes excellent. The specific measuring method thereof is shown in Examples to be described later.

In the following description, the length of the spiral flow of the resin composition having a thickness of 2 mm under conditions of a temperature of 240° C. and an injection pressure of 90 MPa may be simply referred to as “spiral flow length”.

According to the resin composition of the exemplary embodiment, by having the above configuration, a resin molded article having an improved flexural modulus may be obtained. The reason for this is not clear, but is presumed as follows.

In the related art, it has been known to obtain a resin molded article using a resin composition containing a cellulose derivative, such as acetyl cellulose, and a plasticizer. However, in the resin composition containing a cellulose derivative and a plasticizer, the plasticizer is mainly used to compensate for the shortage of flexibility of the cellulose derivative, and the flexural modulus of the resin molded article formed using the resin composition containing the cellulose derivative and the plasticizer easily decreases compared to that of the resin molded article formed using only the cellulose derivative.

As such, since the conventional resin molded article obtained using the resin composition containing the cellulose derivative and the plasticizer has a low flexural modulus, a resin molded article having an improved flexural modulus have been required.

In the resin composition containing a cellulose derivative and a plasticizer, with the increase in the content of the plasticizer, the fluidity of the resin composition is improved. For example, in the case where the value of spiral flow length becomes too large by increasing the amount of the plasticizer in the resin composition, the fluidity of the resin composition becomes too high. When a resin molded article is formed using the resin composition having this too large spiral flow length value, for example, by an injection molding method, the molecular orientation of the cellulose derivative in the obtained resin molded article and the orientation of the plasticizer in the obtained resin molded article are easily disturbed. As a result, the flexural modulus of the obtained resin molded article easily decreases.

Meanwhile, when the content of the plasticizer in the resin composition decreases, the value of spiral flow length of the resin composition becomes too small, and the fluidity of the resin composition becomes too low. When a resin molded article is formed, for example, by an injection molding method, moldability deteriorates, and thus there is a case where the resin molded article is difficult to obtain. Further, even when the resin molded article is obtained, the cellulose derivative is easily solidified before molecular orientation, and the packing density of the resin molded article easily decreases. Therefore, the flexural modulus of the obtained resin molded article easily decreases.

In contrast, in the resin composition according to the exemplary embodiment, the spiral flow length thereof is 100 mm or more and less than 130 mm. When a resin molded article is formed using this resin composition, for example, by an injection molding method, it is considered that, in the obtained resin molded article, the molecular orientation of a cellulose derivative becomes regular easily, and the molecular orientation of a plasticizer also becomes regular. As a result, it is considered that the flexural modulus of the obtained resin molded article is improved.

From the above, since the resin composition according to the exemplary embodiment has the above configuration, it is presumed that a resin molded article having an improved flexural modulus is obtained.

Further, in the resin molded article obtained using the resin composition according to the exemplary embodiment, the molecular orientation of a cellulose derivative and the molecular orientation of a plasticizer are considered to be regular, and thus heat distortion temperature is easily increased.

Hereinafter, components of the resin composition according to the exemplary embodiment will be described in detail.

Acetylcellulose Derivative

The resin composition according to the exemplary embodiment includes an acetylcellulose derivative.

Here, as the cellulose derivative, a cellulose derivative, in which at least one hydroxyl group of cellulose is substituted with a substituent such as an acetyl group, a propionyl group, or the like, is known.

However, in the case where at least one hydroxyl group of cellulose is substituted with a substituent having a large number of carbon atoms, such as a propionyl group, the thermal fluidity of the cellulose derivative substituted with a substituent having a large number of carbon atoms becomes too high. Therefore, in the case where a resin molded article is formed using the resin composition including the cellulose derivative substituted with a substituent having a large number of carbon atoms, the flexibility of the resin molded article is improved, but the flexural modulus thereof is easily deteriorated. Meanwhile, in the case where the hydroxyl group of cellulose is unsubstituted, thermal melting molding (particularly, injection molding) tends to become difficult.

Therefore, in the resin composition according to the exemplary embodiment, a cellulose derivative, in which at least one hydroxyl group of cellulose is substituted with an acetyl group, is used.

An acetyl cellulose derivative is a cellulose derivative in which at least one hydroxyl group of cellulose is substituted with an acetyl group, and, specifically, is preferably a compound represented by the formula (1) below.

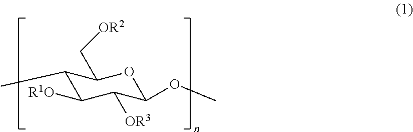

In the formula (1), R¹, R², and R³ each independently represents a hydrogen atom or an acetyl group. n represents an integer of 2 or more; provided that at least one of n R¹s, n R²s, and n R³s represents an acetyl group.

In the formula (1), the range of n is not particularly limited, but may be determined in accordance with the preferable range of a weight average molecular weight. Specifically, the range of n may be 200 to 1000, preferably 250 to 850, and more preferably 300 to 750.

When n is set to 200 or more, the strength of the resin molded article easily becomes high. When n is set to 1000 or less, the deterioration of the flexibility of the resin molded article is easily prevented.

Weight Average Molecular Weight

The weight average molecular weight of the acetylcellulose derivative may be 40,000 or more, preferably 50,000 or more, and more preferably 60,000 or more. The upper limit thereof may be 300,000 or less, and preferably 200,000 or less.

When the weight average molecular weight thereof is within the above range, spiral flow length is easily adjusted to a range of 100 mm or more and less than 130 mm. Further, the flexural modulus of the obtained resin molded article is easily improved.

The weight average molecular weight (Mw) is a value measured by gel permeation chromatography (GPC).

Specifically, the molecular weight measurement by GPC is performed using a solution of dimethylacetamide/lithium chloride having a volume ratio of 90/10 by a GPC apparatus (manufactured by Tosoh Corporation, HLC-8320GPC, Column: TSKgelα-M).

Substitution Degree

The substitution degree of the acetylcellulose derivative is preferably 2.1 to 2.6, and more preferably 2.2 to 2.5, in terms of increasing thermal fluidity.

When the substitution degree thereof is within the above range of 2.1 to 2.6, the deterioration in thermoplasticity of the acetylcellulose derivative is easily prevented. Further, the occurrence of intermolecular packing of the obtained resin molded article is easily prevented. As a result, the flexural modulus and heat distortion temperature of the resin molded article is easily lowered.

Here, the substitution degree refers to an index for showing a degree in which hydroxyl groups of acetylcellulose are substituted with a substituent. In other words, the substitution degree is an index for showing a degree of acetylation of the acetylcellulose derivative. Specifically, the substitution degree means an intramolecular average of the number of substituents for three hydroxyl groups in the D-glucopyranose unit of the acetylcellulose derivative which are substituted with acetyl groups.

The substitution degree is determined from the integration ratio of a cellulose-derived hydrogen and an acetyl group-derived peak by H¹-NMR (JNM-ECA series, manufactured by JEOL RESONANCE Co., Ltd.).

Specific examples of the acetylcellulose derivative are shown as follows, but are not limited thereto.

| | | Name of | | | Weight average | Substitution |
|---|---|---|---|---|---|---|
| | Name of compound | product | Manufacturer | Substituents R¹, R², R³ | molecular weight | degree |
| CE1 | Diacetyl cellulose | L-50 | Daicel | Hydrogen atom or acetyl group | 161,000 | 2.41 |
| CE2 | Diacetyl cellulose | L-20 | Daicel | Hydrogen atom or acetyl group | 119,000 | 2.41 |
| CE3 | Diacetyl cellulose | CA-389-3 | Eastman Chemical | Hydrogen atom or acetyl group | 79,500 | 2.12 |
| CE4 | Triacetyl cellulose | LT-55 | Daicel | Hydrogen atom or acetyl group | 198,000 | 2.91 |

Plasticizer

In the exemplary embodiment, the “non-reactivity” of the non-reactive plasticizer means that the plasticizer does not have a functional group capable of reacting with the acetylcellulose derivative.

The non-reactive plasticizer is not particularly limited as long as it does not have a functional group capable of reacting with the acetylcellulose derivative. Examples of the non-reactive plasticizer include compounds having an ester group, and specific examples thereof include a polyether ester compound and a compound containing an adipic acid ester (hereinafter, also referred to as a “adipic acid ester-containing compound). Among these, an adipic acid ester-containing compound is preferable in that the bleeding of the plasticizer (precipitation phenomenon to the surface) is easily prevented.

Adipic Acid Ester-Containing Compound

An adipic acid ester-containing compound (compound containing adipic acid ester) refers to a compound of adipic acid ester alone, and a mixture of adipic acid ester and components other than adipic acid ester (compound different from adipic acid ester). However, the adipic acid ester-containing compound may preferably contain the adipic acid ester by 50% by weight or more with respect to the total of adipic acid ester and other components.

As the adipic acid ester, for example, adipic acid diester, and adipic acid polyester are exemplified. Specifically, adipic acid diester represented by the formula (2-1) and adipic acid polyester represented by the formula (2-2) are exemplified.

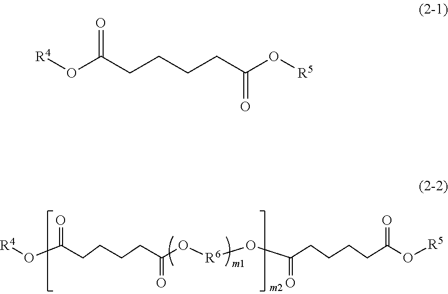

In the formulae (2-1) and (2-2), R⁴ and R⁵ each independently represents an alkyl group, or a polyoxyalkyl group [—(CₓH₂ₓ—O)_{y}—R^{A1}] (where R^{A1} represents an alkyl group, x represents an integer in the range of 1 to 6, and y represents an integer in the range of 1 to 6).

R⁶ represents an alkylene group.

m1 represents an integer in the range of 1 to 5.

m2 represents an integer in the range of 1 to 10.

In the formulae (2-1) and (2-2), the alkyl groups represented by R⁴ and R⁵ are preferably alkyl groups having 1 to 6 carbon atoms, and more preferably alkyl groups having 2 to 4 carbon atoms. The alkyl groups represented by R⁴ and R⁵ may have any one of a linear shape, a branched shape, or a cyclic shape, but preferably a linear shape and a branched shape.

In the formulae (2-1) and (2-2), in the polyoxyalkyl group represented by R⁴ and R⁵ [—(CₓH_{2X}—O)_{y}—R^{A1}], the alkyl group represented by R^{A1} is preferably an alkyl group having 1 to 6 carbon atoms, and more preferably an alkyl group having 2 to 4 carbon atoms. The alkyl group represented by R^{A1} may have any one of a linear shape, a branched shape, or a cyclic shape, but preferably a linear shape and a branched shape.

x represents an integer in the range of 1 to 6, and y represents an integer in the range of 1 to 6.

In the formulae (2-1) and (2-2), the alkylene group represented by R⁶ is preferably an alkylene group having 1 to 6 carbon atoms, and more preferably an alkylene group having 2 to 4 carbon atoms. The alkylene group represented by R⁶ may have any one of a linear shape, a branched shape, or a cyclic shape, but preferably a linear shape and a branched shape.

In the formulae (2-1) and (2-2), the group represented by each of R⁴ to R⁶ may be substituted with a substituent. As the substituent, an alkyl group, an aryl group, and an acyl group are exemplified.

The molecular weight of the adipic acid ester (or weight average molecular weight) is preferably in the range of 100 to 10,000, and more preferably in the range of 200 to 3,000. The weight average molecular weight is a value measured according to the method of measuring the weight average molecular weight of the cellulose derivative described above.

Specific examples of the adipic acid ester-containing compound are described below, but not limited thereto.

| | Name of Material | Name of Product | Manufacturer |
|---|---|---|---|
| ADP1 | Adipic acid | Daifatty 101 | Daihachi Chemical |
| | diester | | Industry Co., Ltd. |
| ADP2 | Adipic acid | Adeka Cizer | ADEKA Corporation |
| | diester | RS-107 | |
| ADP3 | Adipic acid | Polycizer | DIC Corporation |
| | polyester | W-230-H | |
| ADP4 | Adipic acid | Daifatty 121 | Daihachi Chemical |
| | diester | | Industry Co., Ltd. |
| ADP5 | Adipic acid | Daifatty 110 | Daihachi Chemical |
| | diester | | Industry Co., Ltd. |

Polyether Ester Compound

As the polyether ester compound, for example, a polyether ester compound represented by the formula (2-3) is exemplified.

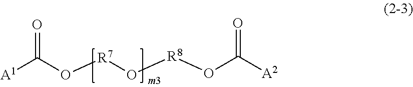

In the formula (2-3), R⁷ and R⁸ each independently represents an alkylene group having 2 to 10 carbon atoms. A¹ and A² each independently represents an alkyl group having 1 to 6 carbon atoms, an aryl group having 6 to 12 carbon atoms, or an aralkyl group having 7 to 18 carbon atoms. m3 represents an integer of 1 or greater.

In the formula (2-3), as the alkylene group represented by R⁷, an alkylene group having 3 to 10 carbon atoms is preferable, and an alkylene group having 3 to 6 carbon atoms is more preferable. The alkylene group represented by R⁷ may have any one of a linear shape, a branched shape, or a cyclic shape, but preferably a linear shape.

If the number of carbons of the alkylene group represented by R⁷ is 3 or greater, the decrease of the fluidity of the resin composition is prevented, and thermoplasticity is easily exhibited. If the number of carbons of the alkylene group represented by R⁷ is 10 or lower, or if the alkylene group represented by R7 has a linear shape, the affinity to the acetylcellulose derivative is easily enhanced.

In this point of view, particularly, the alkylene group represented by R⁷ is preferably a n-hexylene group (—(CH₂)₆—). That is, the polyether ester compound is preferably a compound where R⁷ represents a n-hexylene group (—(CH₂)₆—).

In the formula (2-3), as the alkylene group represented by R⁸, an alkylene group having 3 to 10 carbon atoms is preferable, and an alkylene group having 3 to 6 carbon atoms is more preferable. The alkylene group represented by R⁸ may have any one of a linear shape, a branched shape, or a cyclic shape, but preferably a linear shape.

If the number of carbons of the alkylene group represented by R⁸ is 3 or greater, the decrease of the fluidity of the resin composition is prevented, and the thermoplasticity is easily exhibited. If the number of carbons of the alkylene group represented by R⁸ is 10 or lower, or if the alkylene group represented by R⁸ has a linear shape, the affinity to the acetylcellulose derivative is easily enhanced.

In this point of view, particularly, the alkylene group represented by R⁸ is preferably a n-butylene group (—(CH₂)₄—). That is, the polyether ester compound is preferably a compound where R⁸ represents a n-butylene group (—(CH₂)₄—).

In the formula (2-3), the alkyl groups represented by A¹ and A² are preferably alkyl groups having 1 to 6 carbon atoms, and alkyl groups having 2 to 4 carbon atoms are more preferable. The alkyl groups represented by A¹ and A² may have any one of a linear shape, a branched shape, or a cyclic shape, but preferably a branched shape.

As examples of the aryl groups represented by A¹ and A², an unsubstituted aryl group such as a phenyl group and a naphthyl group and a substituted phenyl group such as a methylphenyl group and a t-butylphenyl group are exemplified.

The aralkyl group represented by A¹ and A² is a group represented by —R^{A}-Ph. R^{A} represents a linear-shaped or branched alkylene group having 1 to 6 carbon atoms (preferably, having 2 to 4 carbon atoms). Ph represents an unsubstituted phenyl group or a substituted phenyl group which is substituted with the linear-shaped or branched alkyl group having 1 to 6 carbon atoms (preferably, having 2 to 4 carbon atoms). As the aralkyl group, specifically, for example, an unsubstituted aralkyl group such as a benzyl group, a phenylmethyl group (phenethyl group), a phenylpropyl group, and a phenylbutyl group, and a substituted aralkyl group such as a methylbenzyl group, a dimethylbenzyl group, and a methylphenethyl group are exemplified.

At least one of A¹ and A² preferably represents an aryl group or an aralkyl group. That is, the polyether ester compound is preferably a compound where at least one of A¹ and A² represents an aryl group (preferably, phenyl group) or an aralkyl group, and preferably a compound where both of A¹ and A² represent an aryl group (preferably, phenyl group) or an aralkyl group, particularly, an aryl group (preferably, phenyl group). The polyether ester compound where at least one of A¹ and A² represents an aryl group (preferably, phenyl group) or an aralkyl group easily form an appropriate space between molecules of the acetylcellulose derivative, and thereby prevent crystallization of celluloses and improve moldability of the resin composition.

In the formula (2-3), the range of m3 is not particularly limited, but, preferably from 1 to 5, more preferably from 1 to 3.

If m3 is 1 or more, bleeding (deposition) of the polyester compound becomes difficult. If m3 is 5 or less, the affinity to the acetylcellulose derivative is easily enhanced.

Subsequently, characteristics of the polyether ester compound are described.

The weight average molecular weight (Mw) of the polyether ester compound is preferably in the range of 450 to 650, and more preferably in the range of 500 to 600.

If the weight average molecular weight (Mw) is 450 or greater, bleeding (phenomenon of deposition) becomes difficult. If the weight average molecular weight (Mw) is 650 or lower, the affinity to the acetylcellulose derivative resin is easily enhanced.

In addition, the weight average molecular weight (Mw) of the polyether ester compound is a value measured by gel permeation chromatography (GPC). Specifically, the measurement of the molecular weight by GPC is performed by using HPLC1100 manufactured by Tosoh Corporation as a measurement apparatus, and TSKgel GMHHR-M+TSKgel GMHHR-M (7.8 mm I.D. 30 cm) which is a column manufactured by Tosoh Corporation, with a chloroform solvent. Also, the weight average molecular weight is calculated by using a molecular weight calibration curve obtained by a monodispersed polystyrene standard sample from the measurement result.

The viscosity of the polyether ester compound at 25° C. is preferably in the range of 35 mPa·s to 50 mPa·s, and more preferably in the range of 40 mPa·s to 45 mPa·s.

If the viscosity is 35 mPa·s or greater, the dispersibility to the acetyl cellulose derivative is easily enhanced. If the viscosity is 50 mPa·s or lower, anisotropy of the dispersion of the polyether ester compound hardly appears.

In addition, the viscosity is a value measured by a B-type viscosmeter.

The Hazen color number (APHA) of the polyether ester compound is preferably 100 to 140, and more preferably 100 to 120.

If the Hazen color number (APHA) is 100 or more, the difference in refractive index between the polyether ester compound and the acetylcellulose derivative is reduced, and a phenomenon of the resin molded article becoming cloudy hardly occurs. If the Hazen color number (APHA) is 140 or less, the resin molded article hardly takes on a yellow tinge. Therefore, if the Hazen color number (APHA) is within the above range, the transparency of the resin molded article is improved.

The Hazen color number (APHA) is a value measured according to JIS-K0071 (1998).

The solubility parameter (SP value) of the polyether ester compound is preferably 9 to 11, and more preferably 9.5 to 10.

If the solubility parameter (SP value) is 9 to 11, the dispersibiity to the acetylcellulose derivative is easily improved.

The solubility parameter (SP value) is a value calculated by the method of Fedor. Specifically, the solubility parameter (SP value) is calculated by the following Equation according to the description of Polym. Eng. Sci., vol. 14, p. 147 (1974).

SP value=√/(Ev/v)=√(ΣΔei/ΣΔvi) Equation:

(In the Equation, Ev: evaporation energy (cal/mol), v: molar volume (cm³/mol), Δei: evaporation energy each atom or atomic group, Δvi: molar volume of each atom or atomic group)

In addition, solubility parameter (SP value) adopts (cal/cm³)^{1/2} as a unit, but may omit the unit in accordance with practice to be represented in a non-dimensional manner.

Here, particularly, the polyether ester compound is preferably a compound in which R⁸ represents a n-butylene group, at least one of A¹ and A² represents an aryl group or an aralkyl group, and weight average molecular weight (Mw) is 450 to 650.

In addition, from the same point of view, the polyether ester compound is preferably a compound in which viscosity at 25° C. is 35 mPa·s to 50 mPa·s, Hazen color number (APHA) is 100 to 140, and solubility parameter (SP value) is 9 to 11.

Hereinafter, specific examples of the polyether ester compound are described, but not limited thereto.

| | R⁷ | R⁸ | A¹ | A² | Mw | Viscosity (25° C.) | APHA | SP value |
|---|---|---|---|---|---|---|---|---|
| PEE1 | —(CH₂)₆— | —(CH₂)₄— | Phenyl group | Phenyl group | 550 | 43 | 120 | 9.7 |
| PEE2 | —(CH₂)₂— | —(CH₂)₄— | Phenyl group | Phenyl group | 570 | 44 | 115 | 9.4 |
| PEE3 | —(CH₂)₁₀— | —(CH₂)₄— | Phenyl group | Phenyl group | 520 | 48 | 110 | 10.0 |
| PEE4 | —(CH₂)₆— | —(CH₂)₂— | Phenyl group | Phenyl group | 550 | 43 | 115 | 9.3 |
| PEE5 | —(CH₂)₆— | —(CH₂)₁₀— | Phenyl group | Phenyl group | 540 | 45 | 115 | 10.1 |
| PEE6 | —(CH₂)₆— | —(CH₂)₄— | t-Butyl group | t-Butyl group | 520 | 44 | 130 | 9.7 |
| PEE7 | —(CH₂)₆— | —(CH₂)₄— | Phenyl group | Phenyl group | 460 | 45 | 125 | 9.7 |
| PEE8 | —(CH₂)₆— | —(CH₂)₄— | Phenyl group | Phenyl group | 630 | 40 | 120 | 9.7 |
| PEE9 | —(CH₂)₆— | —(CH₂)₄— | Phenyl group | Phenyl group | 420 | 43 | 135 | 9.7 |
| PEE10 | —(CH₂)₆— | —(CH₂)₄— | Phenyl group | Phenyl group | 670 | 48 | 105 | 9.7 |
| PEE11 | —(CH₂)₆— | —(CH₂)₄— | Phenyl group | Phenyl group | 550 | 35 | 130 | 9.7 |
| PEE12 | —(CH₂)₆— | —(CH₂)₄— | Phenyl group | Phenyl group | 550 | 49 | 125 | 9.7 |
| PEE13 | —(CH₂)₆— | —(CH₂)₄— | Phenyl group | Phenyl group | 550 | 32 | 120 | 9.7 |
| PEE14 | —(CH₂)₆— | —(CH₂)₄— | Phenyl group | Phenyl group | 550 | 53 | 105 | 9.7 |
| PEE15 | —(CH₂)₆— | —(CH₂)₄— | Phenyl group | Phenyl group | 550 | 43 | 135 | 9.7 |
| PEE16 | —(CH₂)₆— | —(CH₂)₄— | Phenyl group | Phenyl group | 550 | 43 | 105 | 9.7 |
| PEE17 | —(CH₂)₆— | —(CH₂)₄— | Phenyl group | Phenyl group | 550 | 43 | 150 | 9.7 |
| PEE18 | —(CH₂)₆— | —(CH₂)₄— | Phenyl group | Phenyl group | 550 | 43 | 95 | 9.7 |

Polyolefin-Containing Multifunctional Elastomer

The resin composition according to the exemplary embodiment may further include a polyolefin-containing multifunctional elastomer containing a polyolefin, in which olefin monomers are polymerized, as a main component and a functional group having at least one selected from an epoxy group and a glycidyl group. Here, the “containing a polyolefin, in which olefin monomers are polymerized, as a main component” means that the polyolefin is polymerized using 50% by weight or more of olefin monomers with respect to the total monomer components.

Specific examples of the polyolefin-containing multifunctional elastomer include polyolefin-glycidyl methacrylate copolymers in which olefin monomers are polymerized. Specific examples thereof include ethylene-glycidyl methacrylate copolymers, ethylene-vinyl acetate-glycidyl methacrylate copolymers, ethylene-acrylic acid methyl ester-glycidyl methacrylate copolymers, ethylene-acrylic acid ethyl ester-glycidyl methacrylate copolymers, ethylene-acrylic acid butyl ester-glycidyl methacrylate copolymers, ethylene-acrylic acid-acrylic acid ester-glycidyl methacrylate copolymers, ethylene-methacrylic acid ester-glycidyl methacrylate copolymers, copolymers in each of which an ethylene-methacrylic acid-methacrylic acid ester copolymer is graft-polymerized with glycidyl methacrylate, copolymers in each of which an ethylene-propylene copolymer is graft-polymerized with glycidyl methacrylate, copolymers in each of which an ethylene-propylene-diene copolymer is graft-polymerized with glycidyl methacrylate, copolymers in each of which an ethylene-α-olefin copolymer is graft-polymerized with glycidyl methacrylate, copolymers in each of which an ethylene-vinyl acetate copolymer is graft-polymerized with glycidyl methacrylate, propylene-glycidyl methacrylate copolymers, and propylene-glycidyl methacrylate graft copolymers.

The polyolefin-containing multifunctional elastomer is more preferably a compound represented by the formula (3) below. If the compound represented by the formula (3) below is used, the acetyl group or hydroxyl group of the acetylcellulose derivatives easily reacts with an epoxy group or a glycidyl group. Since the distance between the acetylcellulose derivatives is increased by a bond caused by this reaction, the fluidity of the resin composition is easily improved. Further, in the resin molded article after molding, a bonding portion is compressed by pressure keeping, and the space between molecules of the acetylcellulose derivative tends to be densely packed. As a result, flexural modulus and heat distortion temperature is easily improved.

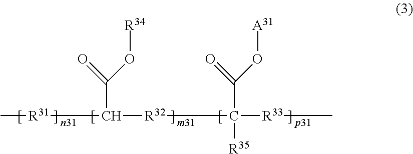

In the formula (3), R³¹ represents a linear alkylene group having 2 to 6 carbon atoms.

R³² and R³³ each independently represents a linear alkylene group having 1 to 6 carbon atoms.

R³⁴ and R³⁵ each independently represents a linear or branched alkyl group having 1 to 4 carbon atoms.

A³¹ represents an epoxy group or a glycidyl group.

n31 represents a integer of 50 to 100, and

m31 and p31 each independently represents an integer of 1 to 50.

In the formula (3), the linear alkylene group having 2 to 6 carbon atoms represented by R³¹ is preferably an alkylene group having 2 to 4 carbon atoms, more preferably an alkylene group having 2 or 3 carbon atoms, and further preferably an alkylene group having 2 carbon atoms (ethylene group (—CH₂CH₂—)).

In the formula (3), the linear alkylene group having 1 to 6 carbon atoms represented by each of R³² and R³³ is preferably an alkylene group having 1 to 4 carbon atoms, more preferably an alkylene group having 1 to 3 carbon atoms, and further preferably an alkylene group having 1 carbon atom (methylene group (—CH₂—)).

In the formula (3), the linear or branched alkyl group having 1 to 4 carbon atoms represented by each of R³⁴ and R³⁵ is preferably a linear or branched alkyl group having 1 to 3 carbon atoms, more preferably a linear alkyl group having 1 or 2 carbon atoms, and further preferably an alkyl group having 1 carbon atom (methyl group (—CH₃)).

In the formula (3), the group represented by A³¹ may be any of an epoxy group or a glycidyl group, but is preferably a glycidyl group.

In the formula (3), the integer represented by n31 is preferably 55 to 100, and more preferably 60 to 100.

The integer represented by m31 is preferably 1 to 40, and more preferably 1 to 30.

The integer represented by p31 is preferably 1 to 40, and more preferably 1 to 30.

In terms of easily improving the flexural modulus of the resin molded article, the compound represented by the formula (3) is preferably a compound in which R³¹ is an ethylene group, each of R³² and R³³ is a methylene group, each of R³⁴ and R³⁵ is a methyl group, and A³¹ is a glycidyl group.

Specific examples of the polyolefin-containing multifunctional elastomer represented by the formula (3) are shown as follows, but are not limited thereto.

In addition, E-MA-GMA represents an ethylene-methylacrylate-glycidylmethacrylate copolymer.

| | Name of material | Name of product | Manufacturer |
|---|---|---|---|
| 1 | E-MA-GMA | LOTADER AX8900 | ARKEMA Corporation |
| 2 | E-MA-GMA | BONDFAST 7M | Sumitomo Chemical Co., |
| | | | Ltd. |
| 3 | E-MA-GMA | BONDFAST 7L | Sumitomo Chemical Co., |
| | | | Ltd. |

Composition of Resin Composition

Contents of Acetylcellulose Derivative and Plasticizer

The resin composition according to the exemplary embodiment includes an acetylcellulose derivative in an amount of 100 parts by weight, and includes a plasticizer in an amount of 5 parts by weight to 20 parts by weight. That is, the content of the plasticizer is 5 parts by weight to 20 parts by weight with respect to 100 parts by weight of the acetylcellulose derivative. In terms of further improving the flexural modulus of the resin molded article, the content of the plasticizer is preferably 5 parts by weight to 18 parts by weight, more preferably 5 parts by weight to 17 parts by weight, and further preferably 5 parts by weight to 15 parts by weight, with respect to 100 parts by weight of the acetylcellulose derivative.

If the content of the plasticizer is 5 parts by weight to 20 parts by weight, spiral flow length is easily controlled in the range of 100 mm or more and less than 130 mm, and the flexural modulus of the obtained resin molded article is improved. Further, if the content of the plasticizer is 20 parts by weight or less, the bleeding of the plasticizer (precipitation phenomenon to the surface) is easily prevented.

In the case where the resin composition includes an acetylcellulose derivative and a plasticizer and does not include a polyolefin-containing multifunctional elastomer, if an acetylcellulose derivative having a low weight average molecular weight is used, spiral flow length is more easily controlled in the range of 100 mm or more and less than 130 mm. In this case, the weight average molecular weight of the acetylcellulose derivative is preferably 40,000 to 120,000, and more preferably 40,000 to 100,000.

Contents of Acetylcellulose Derivative, Plasticizer and Polyolefin-Containing Multifunctional Elastomer

In the case where the resin composition according to the exemplary embodiment further includes a polyolefin-containing multifunctional elastomer, it is preferable that the resin composition includes an acetylcellulose derivative in an amount of 100 parts by weight, includes a plasticizer in an amount of 5 parts by weight to 20 parts by weight (preferably 5 parts by weight to 18 parts by weight, more preferably 5 parts by weight to 17 parts by weight, and further preferably 5 parts by weight to 15 parts by weight), and includes a polyolefin-containing multifunctional elastomer in an amount of 2 parts by weight to 10 parts by weight. That is, the content of the polyolefin-containing multifunctional elastomer is preferably 2 parts by weight to 10 parts by weight with respect to 100 parts by weight of the acetylcellulose derivative. The content of the polyolefin-containing multifunctional elastomer is more preferably 3 parts by weight to 8 parts by weight, and further preferably 4 parts by weight to 7 parts by weight.

If the content of the plasticizer is 5 parts by weight to 20 parts by weight and the content of the polyolefin-containing multifunctional elastomer is 2 parts by weight to 10 parts by weight, spiral flow length is easily controlled in the range of 100 mm or more and less than 130 mm. Further, if the content of the polyolefin-containing multifunctional elastomer is within the above range, the reaction site of an acetyl group or a hydroxyl group of the acetylcellulose derivative with an epoxy group or a glycidyl group becomes a sufficient state, and the space between molecules of the acetylcellulose derivative tends to be densely packed. As a result, a resin molded article having an improved flexural modulus and heat distortion temperature is obtained. Further, if the content of the polyolefin-containing multifunctional elastomer is 10 parts by weight or less, the bleeding of the plasticizer (precipitation phenomenon to the surface) is easily prevented.

In the case where the resin composition includes an acetylcellulose derivative and a plasticizer and further includes a polyolefin-containing multifunctional elastomer, the weight average molecular weight of the acetylcellulose derivative is not particularly limited. In this case, if an acetylcellulose derivative having a weight average molecular weight of 40,000 to 300,000 is used, spiral flow length is easily controlled in the range of 100 mm or more and less than 130 mm.

In the resin composition according to the exemplary embodiment, even in any of the case where the resin composition includes an acetylcellulose derivative and a plasticizer and does not include a polyolefin-containing multifunctional elastomer and the case where the resin composition includes an acetylcellulose derivative, a plasticizer and a polyolefin-containing multifunctional elastomer, the weight percentage of the acetylcellulose derivative to the total resin composition may be 50% by weight or more, preferably 60% by weight or more, and more preferably 70% by weight or more. Further, the upper limit of the weight percentage of the acetylcellulose derivative to the total resin composition may be 96% by weight or less, preferably 95% by weight or less, and more preferably 94% by weight or less.

Other Components

The resin composition according to the exemplary embodiment, if necessary, may further include other components in addition to the above-described components. Examples of these other components include a flame retardant, a compatibilizer, a plasticizer, an antioxidant, a release agent, alight fasting agent, a weathering agent, a colorant, a pigment, a modifier, an anti-drip agent, an antistatic agent, an anti-hydrolyzing agent, a filler, and a reinforcing agent (glass fiber, carbon fiber, talc, clay, mica, glass flake, milled glass, glass bead, crystalline silica, alumina, silicon nitride, aluminum nitride, boron nitride, etc.).

Further, if necessary, components (additives), such as acid acceptor for preventing acetic acid release, a reactive trapping agent, and the like may be added. Examples of the acid acceptor include: oxides, such as magnesium oxide and aluminum oxide; metal hydroxides, such as magnesium hydroxide, calcium hydroxide, aluminum hydroxide, and hydrotalcite; calcium carbonate; and talc.

Examples of the reactive trapping agent include epoxy compounds, acid anhydride compounds, and carbodiimides.

The content of each of these components is preferably 0% by weight to 5% by weight with respect to the total resin composition. Here, the “0% by weight” means that the resin composition does not include these other components.

The resin composition according to the exemplary embodiment may include other resins other than the above-described resin. However, in the case where the resin composition includes these other resins, the weight percentage of these other resins to all the resins may be 5% by weight or less, and preferably less than 1% by weight.

Examples of these other resins include conventionally known thermoplastic resins. Specific examples thereof include polycarbonate resins; polypropylene resins; polyester resins; polyolefin resins; polyester carbonate resins; polyphenylene ether resins, polyphenylene sulfide resins; polysulfone resins; polyether sulfone resins; polyarylene resins; polyether imide resins; polyacetal resins; polyvinyl acetal resins; polyketone resins; polyether ketone resins; polyether ether ketone resins; polyaryl ketone resins; polyether nitrile resins; liquid crystal resins; polybenzimidazole resins; polyparabanic acid resins; vinyl polymer or copolymers obtained by polymerizing or copolymerizing one or more vinyl monomers selected from the group consisting of aromatic alkenyl compounds, methacrylic acid esters, acrylic acid esters, and vinyl cyanide compounds; diene-aromatic alkenyl compound copolymers; vinyl cyanide-diene-aromatic alkenyl compound copolymers; aromatic alkenyl compound-diene-vinyl cyanide-N-phenyl maleimide copolymers; vinyl cyanide-(ethylene-diene-propylene (EPDM))-aromatic alkenyl compound copolymers; vinyl chloride resins; and chlorinated vinyl chloride resins. In addition, core-shell type butadiene-methyl methacrylate copolymers may also be exemplified. These resins may be used alone or in combination of two or more kinds thereof.

Method of Preparing Resin Composition

The resin composition according to the exemplary embodiment, for example, is prepared by molten-kneading a mixture of the above-described components. In addition, the resin composition according to the exemplary embodiment, for example, is prepared by dissolving the above-described components in a solvent. For molten-kneading, known machines may be used, and specific examples thereof include a twin-screw extruder, a HENSCHEL MIXER, a BANBURY MIXER, a single-screw extruder, multi-screw extruder, and a co-kneader.

Resin Molded Article

The resin molded article according to the exemplary embodiment includes the resin composition according to the exemplary embodiment. That is, the resin molded article according to the exemplary embodiment is composed of the same composition as the resin composition according to the exemplary embodiment.

As the molding method of the resin molded article according to the exemplary embodiment, injection molding is preferable, in terms of a high degree of freedom in shape. In this regard, the resin molded article is preferably an injection molded article obtained by injection molding.

The cylinder temperature in injection molding is, for example, 200° C. to 300° C., and preferably 240° C. to 280° C. The mold temperature in injection molding is, for example, 40° C. to 90° C., and preferably 60° C. to 80° C. The injection molding may be performed using commercially available equipment, such as NEX 500 manufactured by NISSEI PLASTIC INDUSTRIAL CO., LTD., NEX 150 manufactured by NISSEI PLASTIC INDUSTRIAL CO., LTD., NEX 70000 manufactured by NISSEI PLASTIC INDUSTRIAL CO., LTD., PNX 40 manufactured by NISSEI PLASTIC INDUSTRIAL CO., LTD., or SE50D manufactured by TOSHIBA MACHINE CO., LTD.

The molding method for obtaining the resin molded article according to the exemplary embodiment is not limited to the above-described injection molding, and examples thereof include extrusion molding, blow molding, heat press molding, calendar molding, coating molding, cast molding, dipping molding, vacuum molding, and transfer molding.

The resin molded article according to the exemplary embodiment is suitably used for applications, such as electrical and electronic equipment, office equipment, household appliances, automobile interior materials, and containers. More specifically, this resin molded article is used for housings of electronic and electrical equipment and household appliances; various parts of electronic and electrical equipment and household appliances; interior parts of automobiles; storage cases of CD-ROM, DVD and the like; dishes; beverage bottles; food trays; wrapping material; films; and sheets.

The flexural modulus of the resin molded article may be more than 2,600 MPa, preferably 2,700 MPa or more, more preferably 2,900 MPa or more, and further preferably 3,000 MPa or more. The upper limit of the flexural modulus is not particularly limited, but may be 4,500 MPa or less in terms of productivity or the like. Particularly, it is preferable that the flexural modulus of the injection molded article is within the above range. If the flexural modulus of the resin molded article obtained from the resin composition including an acetylcellulose derivative and a plasticizer is more than 2,600 MPa, this resin molded article may be suitably used for applications requiring a shape having a wide area and a thin thickness (for example, housings of electronic and electrical equipment and household appliances).

### EXAMPLES

Hereinafter, the present invention will be described in more detail with reference to Examples, but the present invention is not limited to these Examples. Here, the “parts” represent “parts by weight” unless otherwise particularly specified.

Synthesis of Acetylcellulose Derivative

20 kg of cellulose (KC FLOCK W50, manufactured by NIPPON PAPER INDUSTRIES CO., LTD.) is put into 20 L of a 0.1M aqueous hydrochloric acid solution, and heated and stirred at 40° C. to perform acid hydrolysis for 20 minutes.

1 kg of the resultant compound is sprayed with 5 kg of glacial acetic acid, and pre-treated and activated. Then, a mixture of 38 kg of glacial acetic acid, 24 kg of acetic anhydride, and 350 g of sulfuric acid is added thereto, and then esterification is performed with stirring and mixing at a temperature of 40° C. or lower. When fiber pieces have disappeared, the esterification is judged to be completed, thereby obtaining triacetylcellulose.

This triacetylcellulose is dropped into 200 L of distilled water, stirred at room temperature for 1 hour, filtered, and then dried at 60° C. for 72 hours.

After the drying, 20 kg of acetic acid, 10 kg of distilled water, and 800 g of hydrochloric acid are added thereto, and a reaction is performed at 40° C. for 5 hours to obtain 5 kg of a reaction product. Then, 300 g of calcium acetate is added to 5 kg of the reaction product, and then the resultant product is stirred in 100 L of distilled water at room temperature for 2 hours, filtered, and then dried at 60° C. for 72 hours, thereby obtaining an acetylcellulose derivative (DAC1).

An acetylcellulose derivative (DAC2) is obtained in the same treatment as above, except that the acid hydrolysis in a 0.1M aqueous hydrochloric acid solution at 40° C. for 20 minutes is changed to the acid hydrolysis in a 0.1 M aqueous hydrochloric acid solution at 40° C. for 5 minutes.

Further, an acetylcellulose derivative (DAC3) is obtained in the same treatment as above, except that the acid hydrolysis at 40° C. for 20 minutes is changed to the acid hydrolysis at 40° C. for 1 hour.

The weight average molecular weight and substitution degree of each of DAC1, DAC2, and DAC3, measured by the above-described method, are shown in Table 1.

TABLE 1

| No. | Weight average molecular weight (Mw) | Substitution degree |
|---|---|---|
| DAC1 | 61,000 | 2.58 |
| DAC2 | 135,000 | 2.69 |
| DAC3 | 45,000 | 1.85 |

### Examples 1 to 19 and Comparative Examples 1 to 7

Kneading

Cylinder temperature is adjusted, and kneading is carried out at a composition ratio shown in Table 2 by a twin screw kneading machine (TEX41SS, manufactured by TOSHIBA MACHINE CO., LTD.), thereby obtaining a resin composition (pellet).

Injection Molding

The obtained pellet is molded into an ISO multipurpose dumbbell test piece (measuring portion dimension: width 10 mm, thickness 4 mm) using an injection molding machine (NEX 140III, manufactured by Nissei Plastic Industrial Co., Ltd.) at cylinder temperature shown in Table 3. In Comparative Examples 1 and 2, injection molding is impossible because poor plasticization is caused.

Evaluation

Spiral Flow Length

With the obtained pellet, a resin composition is injected using an injection molding machine (NEX 140III, manufactured by Nissei Plastic Industrial Co., Ltd.) and a spiral mold (thickness 2 mm, width 5 mm, maximum flow length 750 mm) under conditions of a resin temperature of 240° C. and an injection pressure of 90 MPa, and the distance from a starting point at which the flow of the resin composition starts in a spiral mold to an endpoint at which the flow of the resin composition stops is measured, and this measured distance is set to spiral flow length.

Flexural Modulus

The flexural modulus of the obtained ISO multipurpose dumbbell test piece is measured using a universal testing machine (AUTOGRAPH AG-XPLUS, manufactured by Shimadzu Corporation) by a method according to ISO-178.

Heat Distortion Temperature

The deflection temperature under load of the obtained ISO multipurpose dumbbell test piece under a load condition of 1.8 MPa is measured using a deflection temperature under load measuring machine (HDT-3, manufactured by Toyo Seiki Seisaku-Sho, Ltd.) by a method according to ISO-78.

TABLE 2

| | | | | | | | | | | PO-containing | | | | | | |
|---|---|---|---|---|---|---|---|---|---|---|---|---|---|---|---|---|
| | | | | | | | | | | multifunctional | | | | | | |
| | Acetyl cellulose derivatives | | | | | | | Plasticizers | | elastomer | | Other resins | | Other additives | | |
| | A | B | C | D | E | F | G | A | B | A | B | A | B | A | B | C |
| Example 1 | | | | 100 | | | | 17 | | | | | | | | |
| Example 2 | | | 100 | | | | | 17 | | 2 | | | | | | |
| Example 3 | 100 | | | | | | | 15 | | 5 | | | | | | |
| Example 4 | 100 | | | | | | | 12.5 | | 5 | | | | | | |
| Example 5 | 100 | | | | | | | 5 | | 10 | | | | | | |
| Example 6 | 100 | | | | | | | 15 | | | 5 | | | | | |
| Example 7 | | 100 | | | | | | 8 | | 3 | | | | | | |
| Example 8 | 100 | | | | | | | 15 | | 5 | | | | 0.5 | | |
| Example 9 | 100 | | | | | | | 15 | | 5 | | | | 1 | | |
| Example 10 | 100 | | | | | | | 15 | | 5 | | | | | 0.5 | |
| Example 11 | 100 | | | | | | | 15 | | 5 | | | | | 1 | |
| Example 12 | | | | | 100 | | | 15 | | 5 | | | | | | |
| Example 13 | | | | | | | 100 | 15 | | 5 | | | | | | |
| Example 14 | 100 | | | | | | | | 15 | 5 | | | | | | |
| Example 15 | 100 | | | | | | | 15 | | | | 0.8 | | | | |
| Example 16 | | | | | | | 100 | 18 | | 1 | | | | | | |
| Example 17 | | | | | | | 100 | 20 | | 1 | | | | | | |
| Example 18 | | | | | | 100 | | 12.5 | | | | | | | | |
| Example 19 | | | 100 | | | | | 12.5 | | | | | | | | |
| Comparative Example 1 | 100 | | | | | | | 4 | | | | | | | | |
| Comparative Example 2 | 100 | | | | | | | 4 | | 5 | | | | | | |
| Comparative Example 3 | 100 | | | | | | | 25 | | | | | | | | 3 |
| Comparative Example 4 | 100 | | | | | | | 25 | | | | | | | | 6 |
| Comparative Example 5 | | 100 | | | | | | 25 | | | | 12.5 | | | | 3 |
| Comparative Example 6 | | 100 | | | | | | 5 | | | | | | | | 1 |
| Comparative Example 7 | 100 | | | | | | | 5 | | | | | 2.5 | | | |

Material species in Table 2 are as follows.

Acetylcellulose Derivatives
Acetyl cellulose derivative A: “L50”, manufactured by Daicel Corporation (weight average molecular weight: 161,000, substitution degree: 2.41)
Acetyl cellulose derivative B: “L20”, manufactured by Daicel Corporation (weight average molecular weight: 119,000, substitution degree: 2.41)
Acetyl cellulose derivative C: “CA-389-3”, manufactured by Eastman Chemical Company (weight average molecular weight: 79,500, substitution degree: 2.12)
Acetyl cellulose derivative D: acetyl cellulose derivative (DAC1) (weight average molecular weight: 61,000, substitution degree: 2.58)
Acetyl cellulose derivative E: acetyl cellulose derivative (DAC2) (weight average molecular weight: 135,000, substitution degree: 2.69)
Acetyl cellulose derivative F: acetyl cellulose derivative (DAC3) (weight average molecular weight: 45,000, substitution degree: 1.85)
Acetyl cellulose derivative G: “LT-55”, manufactured by Daicel Corporation (weight average molecular weight: 198,000, substitution degree: 2.91)

Here, acetyl cellulose derivatives (DAC1, DAC2, and DAC3) are prepared by the above-described acetylcellulose derivative synthesis.

Plasticizer
Plasticizer A: “DAIFATTY-101”, manufactured by Daihachi Chemical Industry Co., Ltd. (adipic acid ester-containing compound)
Plasticizer B: “ADEKACIZER RS1000”, manufactured by ADEKA Corporation (polyether esters)
PO-containing multifunctional elastomer (polyolefin-containing multifunctional elastomer)

PO-containing multifunctional elastomer A: “LOTARDER AX8900”, manufactured by ARKEMA Corporation (ethylene/methyl acrylate/glycidyl methacrylate copolymer, methyl acrylate: 24% by weight, glycidyl methacrylate: 8% by weight)
PO-containing multifunctional elastomer B: “BONDFAST 7M”, manufactured by Sumitomo Chemical Co., Ltd. (Material name: ethylene/methyl acrylate/glycidyl methacrylate copolymer, methyl acrylate: 27% by weight, glycidyl methacrylate: 6% by weight)

Other Resins
Resin A: “PARALOID EXL2602”, manufactured by Dow Chemical Company in Japan (core-shell type butadiene/methyl methacrylate copolymer)
Resin B: “KURARITY LA4285”, manufactured by KURARAY CO., LTD. (block copolymer of methyl methacrylate and butyl acrylate)

Other Additives
Additive A: “CARBODILITE (registered trademark) HMV-15CA”, manufactured by Nisshinbo Holdings, Inc. (carbodiimide)
Additive B: “STARMAG PSF150”, manufactured by Konoshima Chemical Co., Ltd. (magnesium oxide)
Additive C: “DIPENTARITTO”, manufactured by Koei Chemical Co., Ltd. (dipentaerythritol)

TABLE 3

| | | Injection molding | Resin molded article | |
|---|---|---|---|---|
| | SF flow | Cylinder | Flexural | HDT |
| | length | temperature | modulus | (1.8 MPa) |
| | mm | ° C. | MPa | ° C. |
| Example 1 | 108 | 250 | 3400 | 98 |
| Example 2 | 103 | 250 | 3400 | 98 |
| Example 3 | 128 | 240 | 3000 | 92 |
| Example 4 | 115 | 240 | 3200 | 95 |
| Example 5 | 110 | 240 | 3600 | 101 |
| Example 6 | 103 | 240 | 3000 | 90 |
| Example 7 | 108 | 240 | 3800 | 110 |
| Example 8 | 126 | 240 | 3000 | 90 |
| Example 9 | 125 | 240 | 3000 | 89 |
| Example 10 | 128 | 240 | 3100 | 93 |
| Example 11 | 126 | 240 | 3200 | 95 |
| Example 12 | 103 | 250 | 2900 | 90 |
| Example 13 | 101 | 280 | 2900 | 88 |
| Example 14 | 108 | 240 | 2900 | 86 |
| Example 15 | 102 | 240 | 2900 | 83 |
| Example 16 | 126 | 230 | 2800 | 82 |
| Example 17 | 129 | 220 | 2800 | 81 |
| Example 18 | 125 | 230 | 3100 | 92 |
| Example 19 | 126 | 230 | 3100 | 93 |
| Comparative | 37 | Injection molding impossible | | |
| Example 1 | | | | |
| Comparative | 55 | Injection molding impossible | | |
| Example 2 | | | | |
| Comparative | 138 | 220 | 2600 | 68 |
| Example 3 | | | | |
| Comparative | 165 | 220 | 2600 | 63 |
| Example 4 | | | | |
| Comparative | 135 | 220 | 2100 | 60 |
| Example 5 | | | | |
| Comparative | 135 | 220 | 2100 | 62 |
| Example 6 | | | | |
| Comparative | 98 | 220 | 2000 | 60 |
| Example 7 | | | | |

In Table 3, the “SF” represents spiral flow.

The “HDT” represents heat distortion temperature.

From the above results, it is understood that the evaluation results of flexural modulus in Examples are good compared to those in Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition, comprising:
100 parts by weight of a cellulose derivative in which at least one hydroxyl group of cellulose is substituted with an acetyl group; and
from 5 parts by weight to 20 parts by weight of a non-reactive plasticizer that does not have a functional group capable of reacting with the cellulose derivative,
wherein the resin composition exhibits a spiral flow length of 100 mm or more and less than 130 mm as a length of a spiral flow having a thickness of 2 mm under conditions of a temperature of 240° C. and an injection pressure of 90 MPa.

2. The resin composition according to claim 1, wherein the plasticizer is a compound containing an adipic acid ester.

3. The resin composition according to claim 1, wherein the resin composition includes the plasticizer in an amount of 5 parts by weight to 15 parts by weight with respect to 100 parts by weight of the cellulose derivative.

4. The resin composition according to claim 1, wherein a substitution degree of the acetyl group in the cellulose derivative is from 2.1 to 2.6.

5. The resin composition according to claim 1, further comprising a polyolefin-containing multifunctional elastomer containing a polyolefin as a main component and having a functional group including at least one selected from an epoxy group and a glycidyl group.

6. The resin composition according to claim 5, wherein the resin composition includes the polyolefin-containing multifunctional elastomer in an amount of 2 parts by weight to 10 parts by weight.

7. The resin composition according to claim 5, wherein the polyolefin-containing multifunctional elastomer is a compound represented by the formula (3): 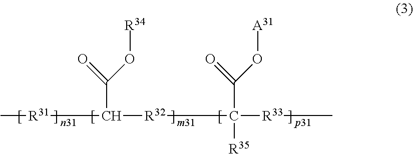
wherein R³¹ represents a linear alkylene group having 2 to 6 carbon atoms, R³² and R³³ each independently represents a linear alkylene group having 1 to 6 carbon atoms, R³⁴ and R³⁵ each independently represents a linear or branched alkyl group having 1 to 4 carbon atoms, A³¹ represents an epoxy group or a glycidyl group, n31 represents a integer of 50 to 100, and m31 and p31 each independently represents an integer of 1 to 50.

8. The resin composition according to claim 1, wherein the weight percentage of the cellulose derivative to the total resin composition is 50% by weight or more.

9. A resin molded article obtained by molding the resin composition according to claim 1.

10. The resin molded article according to claim 9, wherein the resin molded article is an injection-molded article.
